(19) United States
(12) Patent Application Publication
(10) Pub. No.: US 2022/0368083 A1
(43) Pub. Date: Nov. 17, 2022

(54) CONNECTOR MODULE, COMMUNICATION CABLE WITH CONNECTOR, AND CONNECTOR ASSEMBLY

(71) Applicant: SUMITOMO WIRING SYSTEMS, LTD., Mie (JP)

(72) Inventors: Takuma HIBINO, Mie (JP); Harald LUTSCH, Wolfsburg (DE)

(21) Appl. No.: 17/625,329

(22) PCT Filed: Jun. 26, 2020
(86) PCT No.: PCT/JP2020/025298

§ 371 Date: Jan. 6, 2022

(30) Foreign Application Priority Data
Jul. 12, 2019 (JP) 2019-130649

(51) Int. Cl. H01R 13/6584; H01R 13/516; H01R 24/54; H01R 4/28; H01B 11/02

(52) U.S. Cl. CPC H01R 13/6584; H01R 13/516; H01R 24/54; H01R 4/28; H01B 11/02

(57) ABSTRACT

A connector module provided on an end part of a communication cable used in communication of 100 Mbps or faster includes a first terminal, a connector member for accommodating the first terminal, a tubular shield member for covering an outer periphery of the connector member, and a tubular conductive rubber member to be electrically connected to the shield member. The shield member includes an accommodating portion for accommodating a part of the conductive rubber member on a side where an end part of the communication cable is inserted. The conductive rubber member includes a first region to be accommodated into the accommodating portion and a second region not to be accommodated into the accommodating portion. The first and second regions constitute an integrally molded body. The second region has a larger outer diameter than the first region.

### TECHNICAL FIELD

The present invention relates to a connector module, a communication cable with connector and a connector assembly.

This application claims a priority based on Japanese Patent Application No. 2019-130649 filed on Jul. 12, 2019, the contents of which are hereby incorporated by reference.

### BACKGROUND

In recent years, high-speed communication of e.g. 100 Mbps or faster has been required. A communication cable with connector used in such high-speed communication is disclosed, for example, in Patent Document 1. The communication cable with connector of Patent Document 1 includes a communication cable having a conductor, and a shield terminal to be mounted on an end part of the communication cable. The shield terminal includes a terminal unit and an outer conductor for shielding electromagnetic waves. The terminal unit includes an inner conductor functioning as a terminal and a dielectric functioning as a connector.

In a configuration disclosed in Patent Document 1, the shield terminal is accommodated in a first housing. A rubber plug is fit in a rear end part of the first housing. The rear end part of the first housing is an end part on the side of the communication cable. By closing an opening in the rear end part of the first housing with the rubber plug, the opening is held in a liquid-tight manner. The rubber plug is a tubular member to be mounted on the outer periphery of a sheath in the communication cable.

### PRIOR ART DOCUMENT

### Patent Document

Patent Document 1: JP 2018-152174 A

### SUMMARY OF THE INVENTION

### Problems to be Solved

A connector module of the present disclosure is a connector module provided on an end part of a communication cable used in communication of 100 Mbps or faster, and includes a first terminal, a connector member for accommodating the first terminal, a tubular shield member for covering an outer periphery of the connector member, and a tubular conductive rubber member to be electrically connected to the shield member, wherein the shield member includes an accommodating portion for accommodating a part of the conductive rubber member on a side where an end part of the communication cable is inserted, the conductive rubber member includes a first region to be accommodated into the accommodating portion and a second region not to be accommodated into the accommodating portion, the first and second regions constitute an integrally molded body, the second region has a larger outer diameter than the first region, an outer peripheral surface of the first region includes a first projection to be held in contact with an inner peripheral surface of the accommodating portion, and an outer peripheral surface of the second region includes an annular second projection.

A communication cable with connector of the present disclosure includes the connector module of the present disclosure, and a communication cable including a conductor to be electrically connected to the first terminal.

A connector assembly of the present disclosure includes the communication cable with connector of the present disclosure, a signal cable arranged in parallel with the communication cable with connector, and an outer housing for collectively accommodating end parts of the communication cable with connector and the signal cable, wherein the outer housing includes a wall portion constituting a space for accommodating the connector module, and the second projection is in close contact with the wall portion.

### BRIEF DESCRIPTION OF THE DRAWINGS

FIG. 1 is a perspective view of a communication cable with connector including a connector module of a first embodiment.

FIG. 2 is a partially exploded perspective view of the communication cable with connector of the first embodiment.

FIG. 3 is a partially exploded perspective view of a connector member provided in the connector module of the first embodiment.

FIG. 4 is a schematic section along IV-IV shown in FIG. 1.

FIG. 5 is a schematic section along V-V shown in FIG. 1.

FIG. 6 is a perspective view of a shield member provided in the connector module of the first embodiment.

FIG. 7 is a perspective view of the shield member shown in FIG. 6 viewed from an opposite side.

FIG. 8 is a perspective view of a housing of the connector member provided in the connector module of the first embodiment.

FIG. 9 is a perspective view of the housing shown in FIG. 8 viewed from an opposite side.

FIG. 10 is a perspective view of a cover of the connector member provided in the connector module of the first embodiment.

FIG. 11 is a perspective view of the cover shown in FIG. 10 viewed from an opposite side.

FIG. 12 is a transverse section of the communication cable with connector including the connector module of the first embodiment.

FIG. 13 is a perspective view of a first terminal provided in the connector module of the first embodiment.

FIG. 14 is a perspective view of the first terminal shown in FIG. 13 viewed from an opposite side.

FIG. 15 is a perspective view of a housing of a connector member provided in a connector module of a first modification.

FIG. 16 is a perspective view of a cover of the connector member provided in the connector module of the first modification.

FIG. 17 is a transverse section of the connector module of the first modification.

FIG. 18 is a schematic configuration diagram of a connector assembly including the connector module of the first embodiment.

### DETAILED DESCRIPTION TO EXECUTE THE INVENTION

### Problem the Present Disclosure Seeks to Solve

A communication cable with connector may be arranged in parallel with another cable. Examples of the other cable include a signal cable. If the communication cable with connector and the signal cable are arranged in parallel, there is a need to integrally handle the communication cable with connector and the signal cable. Specifically, there is a need to collectively handle end parts of the communication cable with connector and the signal cable as a connector assembly accommodated in an outer housing. At this time, it is desired to ensure water cut-off performance between the communication cable with connector and the outer housing. The shield terminal described in Patent Document 1 is called a connector module.

One object of the present disclosure is to provide a connector module excellent in water cut-off performance. Another object of the present disclosure is to provide a communication cable with connector and a connector assembly excellent in water cut-off performance.

### Effect of Present Disclosure

The connector module, the communication cable with connector and the connector assembly of the present disclosure are excellent in water cut-off performance.

### Description of Embodiment of Present Disclosure

First, contents of embodiments of the present disclosure are listed and described.

(1) The connector module according to an embodiment of the present disclosure is a connector module provided on an end part of a communication cable used in communication of 100 Mbps or faster, and includes a first terminal, a connector member for accommodating the first terminal, a tubular shield member for covering an outer periphery of the connector member, and a tubular conductive rubber member to be electrically connected to the shield member, wherein the shield member includes an accommodating portion for accommodating a part of the conductive rubber member on a side where an end part of the communication cable is inserted, the conductive rubber member includes a first region to be accommodated into the accommodating portion and a second region not to be accommodated into the accommodating portion, the first and second regions constitute an integrally molded body, the second region has a larger outer diameter than the first region, an outer peripheral surface of the first region includes a first projection to be held in contact with an inner peripheral surface of the accommodating portion, and an outer peripheral surface of the second region includes an annular second projection.

The connector module of the present disclosure is mounted on the end part of the communication cable. At this time, the conductive rubber member is mounted on the outer periphery of the shielding layer of the communication cable. A part of the conductive rubber member is accommodated into the accommodating portion of the shield member. Out of the conductive rubber member, the first region to be accommodated into the accommodating portion includes the first projection to be held in contact with the inner peripheral surface of the accommodating portion. The conductive rubber member is electrically connected to the shield member by the first projection. The shield member is grounded. Thus, if the conductive rubber member is mounted on the outer periphery of the shielding layer of the communication cable, an induced current flowing in the shielding layer can be released to ground via the conductive rubber member and the shield member.

The communication cable mounted with the connector module of the present disclosure may be arranged in parallel with another cable. The communication cable mounted with the connector module may be called a communication cable with connector. The other cable is, for example, a signal cable. End parts of the communication cable with connector and the signal cable may be collectively accommodated into an outer housing to configure a connector assembly. Out of the conductive rubber member, the second region not to be accommodated into the accommodating portion has a larger outer diameter than the first region and includes the annular second projection. The conductive rubber member is held in close contact with the inner peripheral surface of the outer housing by the second projection. Since the second region constitutes the integrally molded body together with the first region, the second projection is located near the accommodating portion. With the connector assembly configured, environmental water, which is moisture present in a use environment of the connector module, tends to intrude from the side where the end part of the communication cable is inserted. The environmental water contains moisture in the air. By the close contact of the second projection with the outer housing, the flow of the environmental water toward the accommodating portion from between the communication cable with connector and the outer housing can be suppressed.

As described above, the conductive rubber member of the present disclosure has both a function of a conductive member to release the induced current flowing in the shielding layer of the communication cable to ground and a water cut-off function to suppress the flow of the environmental water toward the accommodating portion in the connector assembly. Thus, the connector module of the present disclosure can be composed of a smaller number of components and better in productivity as compared to the case where the function of the conductive member and the water cut-off function are individually configured.

(2) As an example of the connector module of the present disclosure, the conductive rubber member is made of silicone rubber.

Silicone rubber is relatively soft rubber. Thus, if the conductive rubber member is made of silicone rubber, the following effects are achieved. The conductive rubber member is easily mounted on the outer periphery of the shielding layer of the communication cable. The conductive rubber member is easily fit into the accommodating portion. The first region of the conductive rubber member fit into the accommodating portion is easily held in close contact with both the shielding layer and the inner peripheral surface of the accommodating portion. In the case of configuring the connector assembly including the communication cable with connector, the second region of the conductive rubber member not accommodated into the accommodating portion is easily held in close contact with the inner peripheral surface of the outer housing. For the above reasons, if the conductive rubber member is made of silicone rubber, the assemblability of the connector module and the communication cable with connector is easily improved. Further, if the conductive rubber member is made of silicone rubber, the water cut-off performance of the connector assembly is easily improved.

(3) As an example of the connector module of the present disclosure, the conductive rubber member contains a conductive filler.

As described above, the conductive rubber member is electrically connected to both the shield member and the shielding layer of the communication cable and functions, together with the shield member, to release the induced current flowing in the shielding layer to ground. Since the conductive rubber member contains the conductive filler, electrical connection between the shielding layer and the shield member can be satisfactorily ensured.

(4) As an example of the connector module of the present disclosure, the conductive rubber member includes a small-diameter portion to be held in close contact with a shielding layer of the communication cable, a large-diameter portion having a larger inner diameter than the small-diameter portion and to be held in close contact with a sheath of the communication cable, and a step formed between the small-diameter portion and the large-diameter portion, an end surface of the sheath being hooked to the step.

The end part of the communication cable is stripped. Thus, the shielding layer is exposed from the sheath of the communication cable, and a step is formed between the outer peripheral surface of the sheath and the outer peripheral surface of the shielding layer by an end surface of the sheath. The conductive rubber member includes the small-diameter portion, the large-diameter portion and the step to correspond to the shielding layer, the sheath and the step. Since the conductive rubber member is shaped to correspond to the shape of the communication cable, the conductive rubber member is easily held in closer contact with the communication cable. Specifically, the small-diameter portion is easily held in close contact with the shielding layer thinner in diameter than the sheath. By holding the conductive rubber member in close contact with the shielding layer, the shield member and the shielding layer can be electrically connected via the conductive rubber member. The shield member is grounded. Thus, the induced current flowing in the shielding layer can be released to ground via the conductive rubber member and the shield member. The conductive rubber member has such a length as to extend up to the sheath and is held in close contact with the sheath, whereby the adhesion of environmental water to the shielding layer can be suppressed.

Further, by providing the conductive rubber member with the step to correspond to the shape of the communication cable, this step is stopped in contact with the end surface of the sheath. That is, the conductive rubber member is hooked to the end surface of the sheath. By this hooking, the conductive rubber member can be firmly mounted on the communication cable. This is because the conductive rubber member is less likely to move in an axial direction by being hooked to the end surface of the sheath due to the resilience of the conductive rubber member.

(5) As an example of the connector module of the present disclosure including the small-diameter portion and the large-diameter portion in the conductive rubber member, the step is located in the accommodating portion, and the first projection and the step are at the same position along an axial direction of the conductive rubber member.

The first projection on the conductive rubber member is in contact with the inner peripheral surface of the accommodating portion and pressed radially inward. Since the step is at the same position as this first projection along the axial direction of the conductive rubber member, the above pressing force is applied to a region near the step. Thus, the conductive rubber member is held in closer contact with the region near the step, whereby the conductive rubber member can be more firmly mounted on the communication cable.

(6) As an example of the connector module of the present disclosure, the shield member is a cast body.

Since the shield member is the cast body, the shield member can have no hole open in the peripheral surface thereof. Thus, the shield member formed of the cast body is excellent in electromagnetic wave shielding performance.

By constituting the shield member by the cast body, the shield member can be an integrated object having a non-split structure. Thus, the shield member formed of the cast body is easily mounted on the connector member. Further, the shield member formed of the cast body can be accurately mounted on the connector member. This is because only manufacturing tolerances at the time of casting the shield member have to be considered in the case of mounting the shield member formed of the cast body on the connector member. For example, the shield member can also be configured by combining two press-worked bodies obtained by press-working a plate material like the outer conductor described in Patent Document 1. However, in the case of mounting the shield member formed by combining the two press-worked bodies on the connector member, processing tolerances of the member during press-working and assembling tolerances when the two press-worked bodies are combined need to be considered. From this, the shield member formed of the cast body can be accurately mounted on the connector member as compared to the shield member formed by combining the two press-worked bodies.

(7) As an example of the connector module of the present disclosure in which the shield member is the cast body, the shield member has no hole open in a peripheral surface of the shield member.

The shield member having no hole open in the peripheral surface has no path of electromagnetic waves in the peripheral surface. Thus, the shield member having no hole in the peripheral surface can effectively suppress the superposition of noise on a communication signal flowing in the first terminal. Further, the shield member having no hole in the peripheral surface can effectively suppress the influence of electromagnetic waves radiated from the first terminal on another electrical device located near the connector member.

(8) As an example of the connector module of the present disclosure in which the shield member is the cast body, a minimum value of a thickness of the shield member is 0.25 mm or more and 1.0 mm or less.

The shield member formed of the cast body tends to be thinner than a shield member formed of a press-worked body obtained by press-working a plate material. This is because the fillability of molten metal into a mold at the time of casting needs to be considered if the shield member is formed of the cast body. If the minimum value of the thickness of the shield member is 0.25 mm or more, the fillability of the molten metal at the time of casting the shield member is hardly deteriorated. On the other hand, if the minimum value of the thickness of the shield member is 1.0 mm or less, the enlargement of the shield member can be suppressed.

(9) As an example of the connector module of the present disclosure, Ethernet (registered trademark) standards are satisfied.

The connector module satisfying the Ethernet (registered trademark) standards is suitably used as a connector module provided in a communication cable with connector to be, for example, installed in a vehicle. A communication volume of information tends to extremely increase regardless of wireless or wired in automotive vehicles of recent years. The connector module satisfying the Ethernet (registered trademark) easily communicates a large volume of information at a high speed.

(10) As an example of the connector module of the present disclosure, the first terminal includes an engaging claw, and the connector member includes an engaging recess to be locked to the engaging claw.

The first terminal is firmly fixed to the connector member by the engagement of the engaging claw and the engaging recess. The engaging claw has a complicated shape as compared to the engaging recess. By providing this engaging claw having a complicated shape on the first terminal, the configuration of the connector member can be simplified. Thus, the connector member is easily reduced in size.

(11) A communication cable with connector according to an embodiment of the present disclosure includes the connector module of any one of (1) to (10) described above, and a communication cable including a conductor to be electrically connected to the first terminal.

The communication cable with connector of the present disclosure includes the connector module of the present disclosure. Thus, the communication cable with connector of the present disclosure is excellent in water cut-off performance. The communication cable with connector of the present disclosure can be suitably used as a communication cable with connector used in high-speed communication.

(12) As an example of the communication cable with connector of the present disclosure, the communication cable is a twisted pair cable.

The twisted pair cable is a communication cable used in differential communication suitable for high-speed communication of data. The twisted pair cable is hardly affected by noise. Therefore, the twisted pair cable can be suitably used as a communication cable provided in the communication cable with connector of the present disclosure used in high-speed communication of 100 Mbps or faster.

(13) A connector assembly according to an embodiment of the present disclosure includes the communication cable with connector of either (11) or (12) described above, a signal cable arranged in parallel with the communication cable with connector, and an outer housing for collectively accommodating end parts of the communication cable with connector and the signal cable, wherein the outer housing includes a wall portion constituting a space for accommodating the connector module, and the second projection is in close contact with the wall portion.

The connector assembly in which the communication cable with connector and the signal cable are integrated by the outer housing reduces the number of connections of the connector to a circuit board. This is because a transmission route of the signal cable and a transmission route of the communication cable are constructed only by connecting the connector assembly of the present disclosure to a connector assembly on the circuit board side. The connector module of the present disclosure includes the conductive rubber member provided with the second projection to be held in close contact with the outer housing as described above. The second projection is annularly configured. Thus, the connector assembly of the present disclosure can suppress the flow of environmental water toward the accommodating portion from between the communication cable with connector and the outer housing and is excellent in water cut-off performance by the close contact of the second projection with the outer housing.

(14) As an example of the connector assembly of the present disclosure, the signal cable includes a plurality of second terminals, and pitches of the second terminals are 0.1 mm or more and 2.0 mm or less.

By setting the pitches of the second terminals in the above range, the connector assembly is easily reduced in size.

### DETAILS OF EMBODIMENTS OF PRESENT DISCLOSURE

Specific examples of a connector module, a communication cable with connector and a connector assembly according to embodiments of the present disclosure are described on the basis of the drawings. In figures, the same reference signs denote the same components. Note that the present invention is not limited to these illustrations and is intended to be represented by claims and include all changes in the scope of claims and in the meaning and scope of equivalents.

### First Embodiment

<<Communication Cable with Connector>

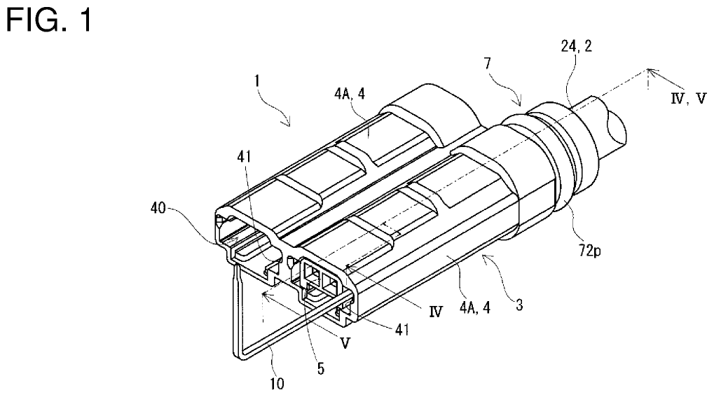

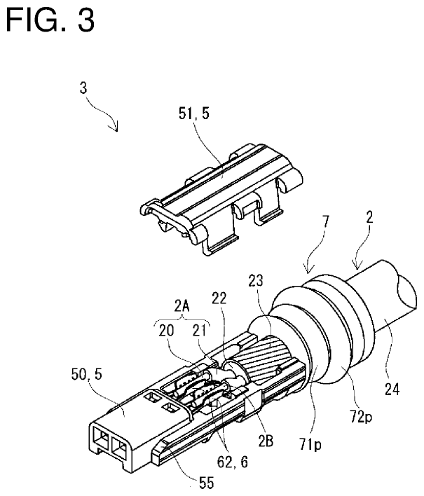

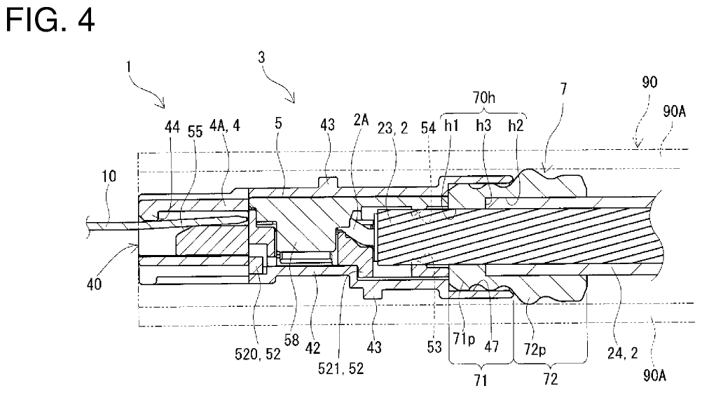

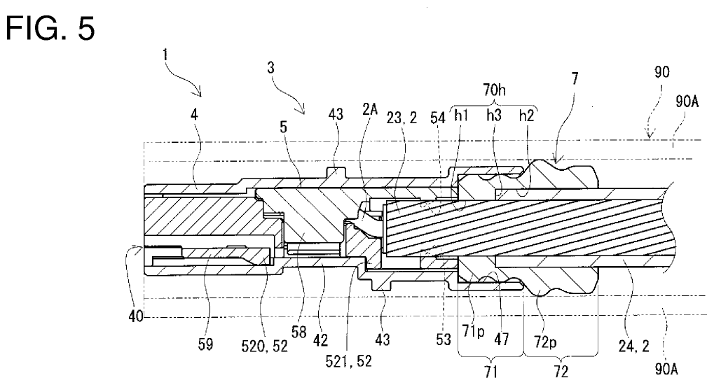

In this example, a communication cable with connector 1 used in wired high-speed communication in an automotive vehicle is described on the basis of FIGS. 1 to 14. Here, FIGS. 1 and 4 show a ground terminal 10 extending from a circuit board (not shown) of an in-vehicle device in addition to the communication cable with connector 1. Although wire barrels 62 of first terminals 6 to be described later are shown to be in an open state in FIG. 3, the wire barrels 62 are actually in a closed state. A shielding layer 23 of a communication cable 2 is not shown in section in FIGS. 4 and 5. A part of an outer housing 90 for accommodating an end part of the communication cable with connector 1 is shown by two-dot chain lines in FIGS. 4 and 5. A vertical direction of FIGS. 1 to 5 does not necessarily coincide with a vertical direction in the automotive vehicle.

The communication cable with connector 1 of the first embodiment includes the communication cable 2 and a connector module 3 provided on an end part of the communication cable 2. The communication cable with connector 1 of this example is a pigtail cable having the connector module 3 provided on one end of the communication cable 2. Unlike this example, the communication cable with connector 1 may be a jumper cable provided with the connector modules 3 on both ends of the communication cable 2.

As shown in FIGS. 1 to 3, the connector module 3 includes the first terminals 6, a connector member 5, a shield member 4, and a conductive rubber member 7. The connector module 3 is configured such that the connector member 5 accommodating the first terminals 6 inside is covered with the shield member 4 and the conductive rubber member 7 is fit in an end part of the shield member 4 on a side where the communication cable 2 is inserted. One feature of the connector module 3 of the first embodiment is that the conductive rubber member 7 includes a first region 71 and a second region 72 as shown in FIGS. 4 and 5. The first region 71 has a function to release an induced current flowing in the shielding layer 23 of the communication cable 2 to ground. The second region 72 has a water cut-off function to suppress the flow of environmental water into the connector module 3 from between the outer housing 90 for accommodating an end part of the communication cable with connector 1 and the communication cable with connector 1. One feature of the communication cable with connector 1 of the first embodiment is to include the connector module 3 of the first embodiment. Hereinafter, the configuration of the communication cable 2 is described and, then, the detailed configuration of the connector module 3 is described.

<<Communication Cable>>

The communication cable 2 is not particularly limited as long as a communication speed of 100 Mbps or faster can be ensured. The communication speed of the communication cable 2 is preferably 1 Gbps or faster. The communication cable 2 of this example is a twisted pair cable satisfying Ethernet (registered trademark) standards. The twisted pair cable is suitable for differential communication less susceptible to noise.

As shown in FIG. 3, the communication cable 2 of this example includes two twisted wires 2A, 2B. The wire 2A, 2B includes a conductor 20 and a conductor insulation layer 21 for covering the outer periphery of the conductor 20. The two twisted wires 2A, 2B are gathered into one by an interposed insulation layer 22. The communication cable 2 further includes the shielding layer 23 provided on the outer periphery of the interposed insulation layer 22 and a sheath 24 for covering the outer periphery of the shielding layer 23. The shielding layer 23 is for shielding electromagnetic waves and, for example, formed by a braided wire made of copper, copper alloy, or aluminum alloy. The sheath 24 is made of insulating resin such as polyvinyl chloride or polyethylene.

The end part of the communication cable 2 is stripped. Specifically, in the end part of the communication cable 2, the shielding layer 23 is exposed from the sheath 24, the interposed insulation layer 22 is exposed from the shielding layer 23, and the respective wires 2A 2B are exposed from the interposed insulation layer 22. The conductor 20 is exposed from the conductor insulation layer 21 on the exposed tip of each wire 2A, 2B.

<<Connector Module>>

As shown in FIGS. 1 to 3, the connector module 3 includes the first terminals 6, the connector member 5, the shield member 4 and the conductive rubber member 7. Each component of the connector module 3 is described in detail below. In describing the respective components, the shield member 4, the conductive rubber member 7, the connector member 5 and the first terminals 6 are described in this order.

[Shield Member]

The shield member 4 is a member for shielding electromagnetic waves radiated from the first terminals 6 (FIG. 3) and the conductors 20 (FIG. 3) of the communication cable 2 and electromagnetic waves from outside of the shield member 4. The shield member 4 is grounded by contacting a ground terminal 10 shown in FIG. 1. Thus, an induced current generated in the shield member 4 by the electromagnetic waves is released to ground. Further, the shield member 4 is electrically connected to the shielding layer 23 (FIG. 3) of the communication cable 2 via the conductive rubber member 7. Thus, an induced current generated in the shielding layer 23 is also released to ground via the conductive rubber member 7 and the shield member 4.

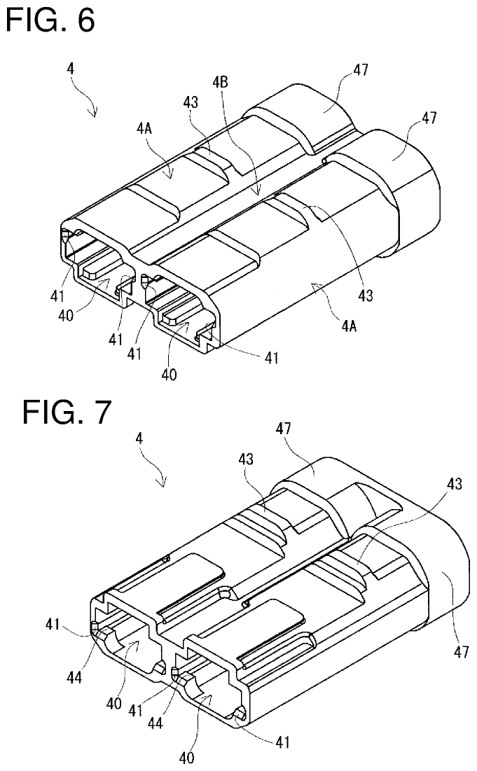

As shown in FIGS. 6 and 7, the shield member 4 of this example includes two tubular bodies 4A and a coupling portion 4B. The two tubular bodies 4A are so arranged laterally side by side that axes thereof are parallel. The coupling portion 4B couples the two tubular bodies 4A along an axial direction. The shield member 4 is an integrated object in which the two tubular bodies 4A and the coupling portion 4B are integrally configured. Either of the two tubular bodies 4A includes a continuous peripheral wall. The peripheral wall has no hole penetrating in an in-out direction thereof. Each tubular body 4A has such a length that the entire connector member 5 can be accommodated inside. Although the connector member 5 is accommodated in one tubular body 4A in FIG. 1, one connector member 5 is actually accommodated in each of the two tubular bodies 4A. The shield member 4 of this example has a function to gather the two communication cables 2 into one and a function to collectively shield electromagnetic waves in the end parts of the two communication cables 2. Unlike this example, the shield member 4 may be composed of one tubular body 4A. Further, three or more tubular bodies 4A may be coupled by coupling portions 4B in the shield member 4.

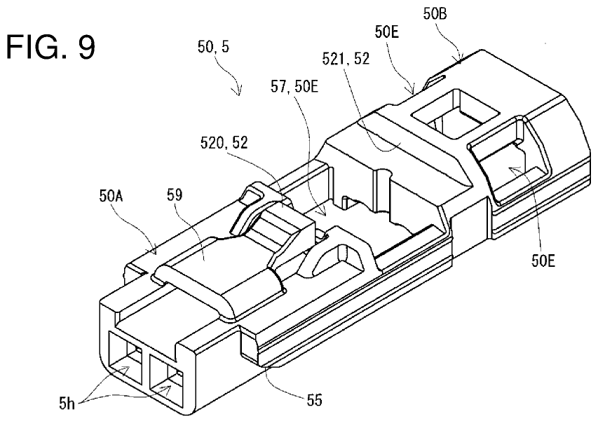

As shown in FIGS. 4 and 5, a shield-side engaging portion 42 to be engaged with the outer periphery of the connector member 5 is provided inside the tubular body 4A. The shield-side engaging portion 42 of this example is an engaging protrusion projecting from the inner peripheral surface of the shield member 4. The shield-side engaging portion 42 has a certain length along the axial direction of the tubular body 4A. The shield-side engaging portion 42 is fit into a space between a resilient projection 520 and a step portion 521 (see also FIG. 9) of connector-side engaging portions 52 provided on the outer periphery of the connector member 5. The engagement of the shield-side engaging portion 42 and the connector-side engaging portions 52 is described in detail later. Unlike this example, the shield-side engaging portion 42 may be an engaging recess.

As shown in FIGS. 6 and 7, a first guide portion 41 is provided in an opening 40 of the shield member 4, into which a mating terminal is inserted. The first guide portion 41 is configured by gradually thinning the shield member 4 from an axially inner side of the tubular body 4A toward the opening 40. The first guide portion 41 is provided at a position corresponding to the ground terminal 10 (FIG. 1) in the opening 40, and guides the ground terminal 10 into the tubular body 4A. By providing the first guide portion 41 in the opening 40, the existing ground terminal 10 provided on the circuit board of the in-vehicle device can be directly used to ground the shield member 4. Thus, in grounding the shield member 4, no special design change is required on the side of the circuit board.

As shown in FIGS. 4 and 7, a protruding portion 44 is provided near the first guide portion 41 in the opening 40. The protruding portion 44 is configured by the projecting inner peripheral surface of the tubular body 4A. The protruding portion 44 is provided on a part of the inner peripheral surface of the tubular body 4A configured to face a second guide portion 55 (FIG. 4) of the connector member 5 to be described later. The protruding portion 44 contacts the outer peripheral surface of the ground terminal 10 curved by the second guide portion 55. That is, the protruding portion 44 serves as an electrical contact point between the shield member 4 and the ground terminal 10.

As shown in FIGS. 4 and 5, an accommodating portion 47 is provided on a side of the shield member 4 where the end part of the communication cable 2 is inserted. A transverse cross-sectional area of an internal region formed by the inner peripheral surface of the accommodating portion 47 is larger than that of an internal region of the shield member 4 except the accommodating portion 47. The transverse cross-sectional area of the internal region of the shield member 4 including the accommodating portion 47 is an area of a cross-section of the internal region formed by the inner peripheral surface of the shield member 4 along a direction orthogonal to a longitudinal direction of the shield member 4. A step is formed between the inner peripheral surface of the accommodating portion 47 and the inner peripheral surface of a region of the shield member 4 continuous with the accommodating portion 47. The transverse cross-sectional shape of the accommodating portion 47 is, for example, a race track shape. The race track shape is a shape obtained by linking end parts of two straight parts parallel to each other and having the same length by arcuate parts. A part of the conductive rubber member 7 arranged on the outer periphery of the shielding layer 23 exposed in the communication cable 2 is fit into the accommodating portion 47. In this example, the first region 71 of the conductive rubber member 7 is fit into the accommodating portion 47. The accommodating portion 47 has such a length that the first region 71 in the conductive rubber member 7 can be accommodated inside the accommodating portion 47.

A material of the shield member 4 is not particularly limited as long as it is an alloy having a high electrical conductivity. The material of the shield member 4 is preferably a zinc alloy. The zinc alloy is an alloy in which a most contained element is zinc (Zn), out of elements constituting the alloy. For example, the zinc alloy is an alloy containing at least one element selected from a group composed of aluminum (Al), magnesium (Mg), iron (Fe), lead (pb), cadmium (Cd) and tin (Sn) besides zinc. Since the zinc alloy is excellent in electrical conductivity and strength, it is suitable as the material of the shield member 4. Further, the zinc alloy is suitable as the material of the shield member 4 also because of its inexpensiveness.

The shield member 4 is, for example, a cast body fabricated by filling molten metal into a mold. The shield member 4 of this example is a die-cast member formed by filling the molten metal into the mold under pressure. If the shield member 4 is a cast body made of zinc alloy, the thin shield member 4 can be easily manufactured with good dimensional accuracy. This is because molten zinc alloy is low in viscosity and easily spreads into narrow clearances of the mold.

If the shield member 4 is formed of a cast body, a minimum value of a thickness of the shield member 4 is preferably 0.25 mm or more and 1.0 mm or less. The minimum value of the thickness of the shield member 4 here excludes a thickness at a position of an inclined surface of the first guide portion 41. A minimum distance between the inclined surface of the first guide portion 41 and the outer peripheral surface of the shield member 4 can be less than 0.25 mm. If the minimum value of the thickness of the shield member 4 is 0.25 mm or more, the fillability of the molten metal at the time of casting the shield member 4 is hardly deteriorated. If the minimum value of the thickness of the shield member 4 is 0.25 mm or more, sufficient strength of the shield member 4 can be ensured. On the other hand, if the minimum value of the thickness of the shield member is 1.0 mm or less, the enlargement/large weight of the shield member can be suppressed. The minimum value of the thickness of the shield member 4 is, for example, preferably 0.3 mm or more and 0.9 mm or less.

As shown in FIGS. 6 and 7, the shield member 4 preferably includes locally thickened thick portions 43. In this example, the thick portions 43 are formed on one surface side of the shield member 4 shown in FIG. 6 and the other surface side of the shield member 4 shown in FIG. 7. By providing the thick portions 43 on the shield member 4, the fillability of the molten metal at the time of casting the shield member 4 can be improved. Further, the strength of the shield member 4 can be improved by the thick portions 43.

[Conductive Rubber Member]

As shown in FIGS. 3 to 5, the conductive rubber member 7 is a tubular member arranged on the outer periphery of a region from the exposed shielding layer 23 to the sheath 24 in the communication cable 2. The conductive rubber member 7 includes the first and second regions 71, 72. The first region 71 is accommodated into the accommodating portion 47 of the shield member 4. The second region 72 is not accommodated into the accommodating portion 47. The first and second regions 71, 72 constitute an integrally molded body.

First Region

The first region 71 includes first projections 71p on an outer peripheral surface. The first projections 71p contact the inner peripheral surface of the accommodating portion 47. With the first region 71 accommodated in the accommodating portion 47, the first projections 71p are pressed radially inward by the inner peripheral surface of the accommodating portion 47. The first projections 71p are held in close contact with the inner peripheral surface of the accommodating portion 47 by repulsive forces against this pressing.

The end part of the communication cable is stripped as described above, and the shielding layer 23 is exposed from the sheath 24 of the communication cable 2. Thus, a step is formed between the outer peripheral surface of the sheath 24 and the outer peripheral surface of the shielding layer 23 by an end surface of the sheath 24 (see FIGS. 4 and 5). In this example, the end surface of the sheath 24 is located in the accommodating portion 47. Thus, the first region 71 of this example is arranged on the outer periphery of the region from the shielding layer 23 to the sheath 24 of the communication cable 2 and held in close contact with both the shielding layer 23 and the sheath 24.

By the contact of the first projections 71p with the inner peripheral surface of the accommodating portion 47, electrical connection between the shield member 4 and the shielding layer 23 can be ensured. The shield member 4 is grounded by contacting the ground terminal 10 (FIGS. 1 and 4) as described above. Thus, an induced current flowing in the shielding layer 23 is released to ground via the conductive rubber member 7 and the shield member 4. That is, the first region 71 has a function of a conductive member to release the induced current flowing in the shielding layer 23 to ground.

A projection amount of the first projection 71p can be so appropriately selected that the tip of the first projection 71p contacts the inner peripheral surface of the accommodating portion 47 with the first region 71 accommodated in the accommodating portion 47. Note that a space is provided between an interval between the adjacent first projections 71p and the inner peripheral surface of the accommodating portion 47.

A transverse cross-sectional shape of an envelope outer shape formed by the tips of the first projections 71p in the first region 71 is, for example, similar to that of the accommodating portion 47. The transverse cross-sectional shape of the envelope outer shape in the first region 71 may not be similar to that of the accommodating portion 47. In this example, the transverse cross-sectional shape of the envelope outer shape in the first region 71 is circular. At this time, if the transverse cross-sectional shape of the accommodating portion 47 is a race track shape, the first region 71 is deformed to be stretched toward wide sides in a transverse cross-section of the accommodating portion 47 when being accommodated into the accommodating portion 47. In this case, parts of the first projections 71p located on narrow sides in the transverse cross-section of the accommodating portion 47 are more strongly held in close contact with the inner peripheral surface of the accommodating portion 47 than parts of the first projections 71p located on the wide sides of the accommodating portion 47.

In a state accommodated in the accommodating portion 47, the first region 71 has the space between the interval between the adjacent first projections 71p and the inner peripheral surface of the accommodating portion 47. Thus, the first region 71 has a smaller contact area with the inner peripheral surface of the accommodating portion 47 as compared to the case where the first region 71 has a cylindrical outer peripheral surface formed by a cylindrical surface without including any projection. Thus, the first region 71 is more easily fit into the accommodating portion 47 as compared to the case where the first region 71 is cylindrical.

The first projections 71p of this example are annularly provided. In the case of the annular first projections 71p, the accommodating portion 47 can be sealed by the first projections 71p. Thus, even if environmental water intrudes into the outer housing 90 to be described later, the intrusion of water into the connector module 3 from the accommodating portion 47 can be prevented.

The first projections 71p may be provided to extend in a direction intersecting a circumferential direction of the conductive rubber member 7. Further, the first projections 71p may be provided to continuously extend from one end part to the other end part of the first region 71. For example, the first region 71 may have a spur gear shape in which a plurality of first projections 71p extend along an axial direction of the conductive rubber member 7. The first region 71 having a spur gear shape can ensure conduction between the shield member 4 and the shielding layer 23 via the first region 71 over the entire length in the axial direction of the conductive rubber member 7. Further, the first region 71 having a spur gear shape is easily fit into the accommodating portion 47 along contact parts of the inner peripheral surface of the accommodating portion 47 and the first projections 71p. Besides, the first region 71 may have a helical gear shape in which a plurality of first projections 71p extend obliquely to the axial direction of the conductive rubber member 7. The first region 71 having a helical gear shape can ensure conduction between the shield member 4 and the shielding layer 23 via the first region 71 over the entire length in the axial direction of the conductive rubber member 7, similarly to the first region 71 having a spur gear shape. Since the first region 71 having a spur gear shape can be screwed into the accommodating portion 47 while rotating the conductive rubber member 7 in the same direction as a twist direction of teeth, this first region 71 can be even more easily fit into the accommodating portion 47 than the first region 71 having a spur gear shape.

The number of the first projections 71p can be appropriately selected so that electrical connection to the shield member 4 can be ensured with the first region 71 accommodated in the accommodating portion 47. To satisfactorily ensure the above electrical connection, it is preferable to provide a plurality of the first projections 71p. Two annular first projections 71p are provided in this example.

Second Region

The second region 72 has a larger outer diameter than the first region 71. The second region 72 includes an annular second projection 72p on an outer peripheral surface. The second projection 72p is provided to be located outwardly of the outer peripheral surface of the shield member 4. The communication cable with connector 1 may be configured as a connector assembly 9 (FIG. 18) by being accommodated into the outer housing 90. The connector assembly 9 is described in detail in a second embodiment. The outer housing 90 collectively accommodates end parts of the communication cable with connector 1 and a cable arranged in parallel with the communication cable with connector 1. The cable arranged in parallel with the communication cable with connector 1 is, for example, a signal cable 8 shown in FIG. 18. The outer housing 90 includes a wall portion 90A constituting a space for accommodating the end part of the communication cable with connector 1, i.e. the connector module 3. The second projection 72 contacts the wall portion 90A. With the connector module 3 accommodated in the outer housing 90, the second projection 72p is pressed radially inward by the wall portion 90A. The second projection 72p is held in close contact with the wall portion 90A by a repulsive force against this pressing. The second region 72 is arranged on the outer periphery of the sheath 24 of the communication cable 2 and held in close contact with the sheath 24.

Since the second region 72 is a molded body integrated with the first region 71, the second projection 72p is located near the accommodating portion 47. The second projection 72p of this example is located to contact the rear end surface of the accommodating portion 47. With the connector assembly 9 (FIG. 18) configured, environmental water tends to intrude from the side where the end part of the communication cable 2 is inserted. Thus, by the contact of the second projection 72p with the wall portion 90A, the flow of the environmental water toward the accommodating portion 47 from between the communication cable with connector 1 and the outer housing 90 can be suppressed. That is, the second region 72 has a water cut-off function to suppress the flow of the environmental water toward the accommodating portion 47 in the connector assembly 9 (FIG. 18).

A projection amount of the second projection 72p can be so appropriately selected that the tip of the second projection 72p contacts the wall portion 90A of the outer housing 90 with the connector module 3 accommodated in the outer housing 90.

A transverse cross-sectional shape of an envelope outer shape formed by the tip of the second projection 72p in the second region 72 is, for example, similar to that of an accommodation space for the communication cable with connector 1 in the outer housing 90. The transverse cross-sectional shape of the envelope outer shape in the second region 72 may not be similar to that of the accommodation space for the communication cable with connector 1 in the outer housing 90. In this example, the transverse cross-sectional shape of the envelope outer shape in the second region 72 is circular. The transverse cross-sectional shape of the accommodation space for the communication cable with connector 1 in the outer housing 90 is, for example, rectangular (see FIG. 18). In this case, the second region 72 is deformed to be stretched toward wide sides in a transverse cross-section of the accommodation space when being accommodated into the accommodation space. Parts of the second projection 72p located on narrow sides in the transverse cross-section of the accommodation space are more strongly held in close contact with the wall portion 90A than parts of the second projection 72p located on the wide sides of the accommodation space.

A space is formed between a region of the second region 72 other than the second projection 72p and the wall portion 90A of the outer housing 90. Thus, the second region 72 has a smaller contact area with the wall portion 90A as compared to the case where the second region 72 has a cylindrical outer peripheral surface formed by a cylindrical surface without including any projection. Thus, the second region 72 is more easily fit into the accommodation space for the communication cable with connector 1 in the outer housing 90 as compared to the case where the second region 72 is cylindrical.

The number of the second projections 72p can be appropriately selected so that water cut-off performance can be ensured between the wall portion 90A and the second projection(s) 72p with the connector module 3 accommodated in the outer housing 90. Since the second projection 72p is annular, the water cut-off performance can be satisfactorily ensured even if one second projection 72p is provided. It is also possible to provide a plurality of the second projections 72p. One annular second projection 72p is provided in this example.

Constituent Material of Conductive Rubber Member

The conductive rubber member 7 is configured as a molded body of a composite material in which a conductive filler is dispersed in one of various rubber materials such as natural rubber or synthetic rubber. Silicone rubber can be suitably used as a rubber material. Silicone rubber is relatively soft rubber. Thus, if the conductive rubber member 7 is made of silicone rubber, the following effects are achieved. The conductive rubber member 7 is easily mounted on the outer periphery of the shielding layer 23 of the communication cable 2. The conductive rubber member 7 is easily fit into the accommodating portion 47 of the shield member 4. The first region 71 of the conductive rubber member 7 fit into the accommodating portion 47 is easily held in close contact with both the shielding layer 23 and the inner peripheral surface of the accommodating portion 47. In the case of configuring the connector assembly 9 (FIG. 18) including the communication cable with connector 1, the second region 72 of the conductive rubber member 7 not accommodated into the accommodating portion 47 is easily held in close contact with the wall portion 90A constituting the inner peripheral surface of the outer housing 90. For the above reasons, if the conductive rubber member 7 is made of silicone rubber, the assemblability of the connector module 3 and the communication cable with connector 1 is easily improved. Further, if the conductive rubber member 7 is made of silicone rubber, the water cut-off performance of the connector assembly 9 (FIG. 18) is easily improved. Examples of the conductive filler include conductive carbon black and metal powder. Examples of metal powder include aluminum powder, copper powder, silver powder and the like.

Configuration for Assisting Mounting of Conductive Rubber Member on Communication Cable

As shown in FIGS. 4 and 5, the conductive rubber member 7 includes a cable hole 70h through which the communication cable 2 is inserted. The cable hole 70h includes a small-diameter portion h1 and a large-diameter portion h2 having a larger inner diameter than the small-diameter portion h1. The small-diameter portion h1 is arranged on the side of the exposed shielding layer 23. The inner peripheral surface of the small-diameter portion h1 is in close contact with the shielding layer 23. The large-diameter portion h2 is arranged on the side of the sheath 24. The inner peripheral surface of the large-diameter portion h2 is in close contact with the sheath 24. A step h3 is present between the small-diameter portion h1 and the large-diameter portion h2. The step h3 is equivalent to a thickness of the sheath 24. That is, the inner diameter of the large-diameter portion h2 in the conductive rubber member 7 corresponds to an outer diameter of the communication cable 2. The conductive rubber member 7 is easily held in close contact with the communication cable 2 by the step h3. The end surface of the sheath 24 is hooked to the step h3. By hooking the conductive rubber member 7 to the step h3, the conductive rubber member 7 can be firmly mounted on the communication cable 2. This is because the conductive rubber member 7 is less likely to move in the axial direction by the hooking of the conductive rubber member 7 to the step h3 due to the resilience of the conductive rubber member 7.

In this example, the step h3 is located in the accommodating portion 47 of the shield member 4. The first projection 71p and the step h3 are at the same position along the axial direction of the conductive rubber member 7. The first projections 71p in the conductive rubber member 7 are in contact with the inner peripheral surface of the accommodating portion 47 and pressed radially inward as described above. Since the step h3 is located at the same position as the first projection 71p along the axial direction of the conductive rubber member 7, the above pressing force is applied to a region near the step h3. Thus, the conductive rubber member 7 is held in closer contact with the region near the step h3, whereby the conductive rubber member 7 can be more firmly mounted on the communication cable 2.

[Connector Member]

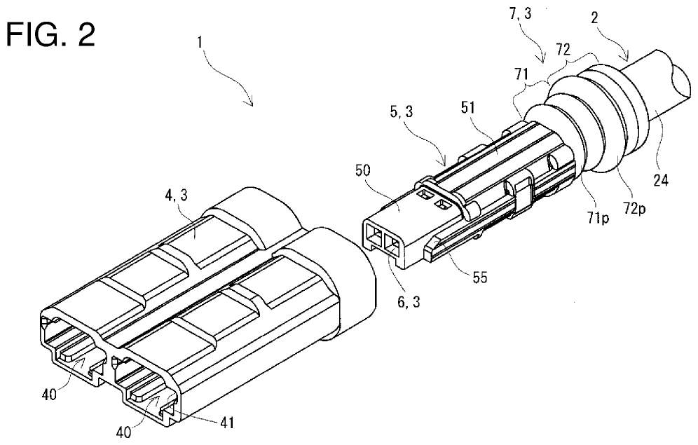

The connector member 5 accommodates the first terminals 6 to be described later. Further, the connector member 5 is accommodated into the shield member 4. The connector member 5 of this example includes a housing 50 and a cover 51 as shown in FIGS. 2 and 3. Both the housing 50 and the cover 51 are made of insulating resin such as polybutylene terephthalate, polyamide or polyethylene.

Housing

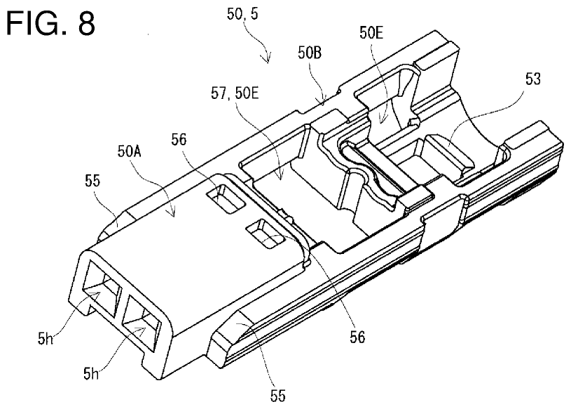

As shown in FIGS. 8 and 9, the housing 50 includes a connector tube portion 50A and a pedestal portion 50B. The tips of the first terminals 6 (FIG. 3) are inserted into the connector tube portion 50A. The pedestal portion SOB supports connected parts of the first terminals 6 and the conductors 20 (FIG. 3) of the communication cable 2 from below. An upper side of the pedestal portion SOB is open.

The connector tube portion 50A includes two insertion holes 5h into which the first terminals 6 (FIG. 3) are inserted. The connector tube portion 50A is provided with engaging recesses 56 communicating with the insertion holes 5h from the outer peripheral surface thereof. The engaging recesses 56 are engaging holes. The engaging recesses 56 may be recesses formed in the inner peripheral surfaces of the insertion holes 5h. An engaging claw 63 (FIG. 13) of the first terminal 6 to be described later is engaged with this engaging recess 56.

The pedestal portion SOB includes housing-side engaging portions 50E and a through hole 57. The housing-side engaging portions 50E are used to couple the housing 50 and the cover 51. The housing-side engaging portions 50E of this example are formed by engaging holes penetrating through the pedestal portion SOB. The through hole 57 is provided at a position corresponding to the connected parts of the first terminals 6 and the conductors 20 of the communication cable 2 shown in FIG. 3. The through hole 57 is provided to facilitate a connecting operation of the first terminals 6 and the conductors 20. The through hole 57 doubles as the housing-side engaging portion 50E. Unlike this example, the housing-side engaging portions 50E may be engaging claws.

Cover

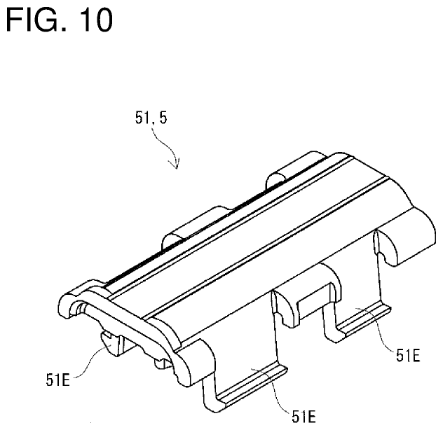

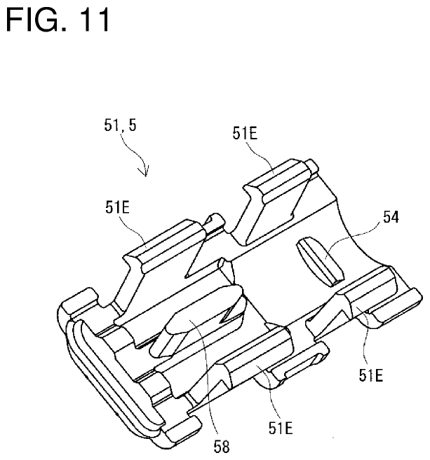

The cover 51 is a member for covering openings of the pedestal portion SOB in the housing 50. As shown in FIGS. 10 and 11, the cover 51 includes a plurality of cover-side engaging portions ME. The cover-side engaging portions 51E of this example are engaging claws to be fit into the housing-side engaging portions 50E formed by the engaging holes. By the engagement of the engaging claws and the engaging holes, the cover 51 is firmly fixed to the housing 50. Unlike this example, the housing-side engaging portions 50E may be formed by engaging claws and the cover-side engaging portions 51E may be formed by engaging holes.

As shown in FIG. 11, the cover 51 includes a partitioning portion 58 projecting from the inner peripheral surface thereof. In this example, the communication cable 2 is a twisted pair cable and includes two wires 2A, 2B. Thus, the connected parts of the first terminals 6 and the conductors 20 of the communication cable 2 are arranged in parallel at two positions (see FIG. 3). The partitioning portion 58 is interposed between the connected parts arranged in parallel. Insulation between the connected parts arranged in parallel is ensured by the partitioning portion 58.

Configuration for Fixing Communication Cable to Connector Member

As shown in FIGS. 4 and 5, the connector member 5 of this example includes clamp portions 53, 54 inside. One clamp portion 53 is provided on the inner peripheral surface of the pedestal portion 50B of the housing 50 as shown in FIG. 8. More specifically, the clamp portion 53 is provided on a bottom part of the pedestal portion 50B facing the shielding layer 23 (FIGS. 4 and 5) of the communication cable 2. The clamp portion 53 of this example is a wide claw-like member long in a width direction of the housing 50. A projection amount of the clamp portion 53 increases toward the connector tube portion 50A. Therefore, the clamp portion 53 has a substantially right triangular shape in a side view.

As shown in FIG. 11, the other clamp portion 54 is provided on the inner peripheral surface of the cover 51. More specifically, the clamp portion 54 is provided at a position facing the clamp portion 53 (FIG. 8) on a body part of the cover 51 except the cover-side engaging portions 51E. The clamp portion 54 of this example is a claw-like member having substantially the same width as the clamp portion 53. A projection amount of the clamp portion 54 decreases after increasing toward the partitioning portion 58. An angle of inclination of a surface of the clamp portion 54 on the side of the partitioning portion 58 is larger than that of a surface on an opposite side to the partitioning portion 58, i.e. a surface on the side of the communication cable 2. Therefore, the clamp portion 54 has a substantially scalene triangular shape in a side view.

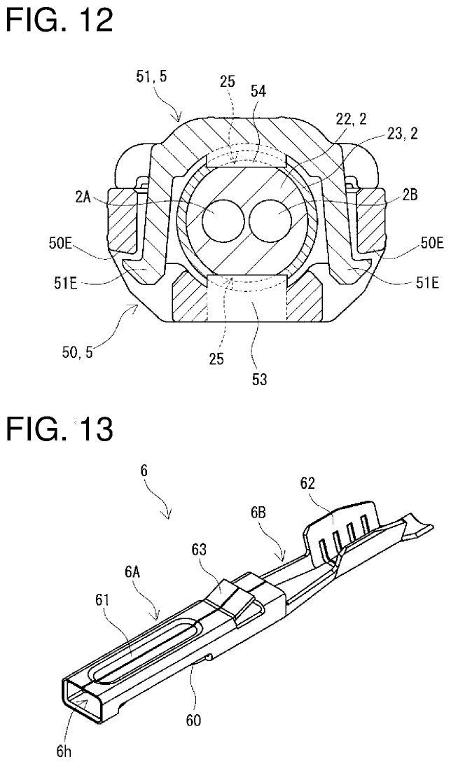

FIG. 12 is a section of the communication cable with connector 1 along a direction orthogonal to the longitudinal direction of the communication cable with connector 1 at the position of the clamp portions 53, 54. As shown in FIG. 12, the clamp portions 53, 54 bite into the interposed insulation layer 22 from the outer periphery of the shielding layer 23 of the communication cable 2. In this example, the interposed insulation layer 22 is provided with cut portions 25 for receiving the clamp portions 53, 54 in advance. Unlike this example, the clamp portions 53, 54 may bite into the interposed insulation layer 22 by pressing the outer periphery of the interposed insulation layer 22 when the housing 50 and the cover 51 are engaged. In either case, the connector member 5 is firmly fixed to the end part of the communication cable 2 by the clamp portions 53, 54. Even if the shielding layer 23 is deformed by the clamp portions 53, 54, the shielding performance of the communication cable with connector 1 is not reduced. This is because the outer periphery of the connector member 5 is covered by the shield member 4 excellent in shielding performance in the communication cable with connector 1 of this example.

Here, in a conventional communication cable with connector, a communication cable and a connector member are engaged by a crimp ring made of metal (see, for example, Japanese Patent Laid-Open Publication No. 2017-126408, etc.). More specifically, the crimp ring is mounted on the outer periphery of a sheath of the communication cable. A part of the crimp ring protrudes radially outwardly of the ring. This protruding part is fit into a cut groove formed in the connector member, whereby the communication cable and the connector member are engaged. However, in a configuration using the crimp ring, the connector member tends to be long. This is because the connector member has to have such a length capable of enclosing the crimp ring gripping the sheath. For example, in the case of providing a crimp ring for the connector member 5 according to this embodiment, a length of the connector member 5 is about 23 mm.

As compared to the conventional connector member using the crimp ring, the connector member 5 of this example is short. This is because the clamp portions 53, 54 grip a part of the communication cable 2 having the sheath 24 stripped therefrom in the connector member 5 of this example. In the configuration for gripping the communication cable 2 by the clamp portions 53, 54, the length of the connector member 5 can be 22 mm or less. If the connector member 5 is made shorter, the shield member 4 for covering the connector member 5 can also be made shorter. Thus, the connector module 3 is considerably reduced in weight. A more preferable length of the connector member 5 is 20 mm or less. A lower limit value of the length of the connector member 5 is about 10 mm

Configuration for Assisting Contact of Ground Terminal and Shield Member

As shown in FIG. 8, the connector member 5 includes second guide portions 55 lateral to the insertion holes 5h. The second guide portion 55 has an inclined surface inclined away from the shield member 4 toward the side of the connector member 5 where the mating terminal are inserted. Thus, the ground terminal 10 inserted into the shield member 4 is curved toward the shield member 4 along the inclined surface of the second guide portion 55. The curved ground terminal 10 contacts the protruding portion 44 provided in the shield member 4. A region of the ground terminal 10 closer to the tip than the second guide portion 55 tries to return to a straight state between the connector member 5 and the shield member 4. Thus, the curved ground terminal 10 is strongly pressed against the protruding portion 44. Therefore, even if the connector module 3 vibrates according to the vibration of the automotive vehicle, electrical connection of the shield member 4 and the ground terminal 10 is easily secured.

Fixing of Connector Member to Shield Member

As shown in FIGS. 4 and 5, the connector member 5 includes the connector-side engaging portions 52 to be engaged with the shield-side engaging portion 42 of the shield member 4. As shown in FIG. 9, the connector-side engaging portions 52 are provided on the outer peripheral surface of the housing 50. Specifically, the connector-side engaging portion 52 is composed of the resilient projection 520 provided on the connector tube portion 50A and the step portion 521 provided on the pedestal portion 50B. The resilient projection 520 is cantilevered and supported on a rear end part of an arched portion 59 provided on the outer peripheral surface of the connector tube portion 50A. The rear end part of the arched portion 59 is an end part of the connector tube portion 50A on the side of the pedestal portion SOB. A surface of the resilient projection 520 on a tip side of the connector member 5 is an inclined surface. The tip side is a side of the connector tube portion 50A opposite to the pedestal portion SOB. Further, a surface of the resilient projection 520 on the side of the pedestal portion SOB is a vertical surface. The step portion 521 is formed by locally thickening the pedestal portion SOB. A surface of the step portion 521 on the tip side of the connector member 5 is a vertical surface.

The connector member 5 is inserted into the shield member 4 through the side of the accommodating portion 47 (see FIG. 5). As the connector member 5 is inserted into the shield member 4, the resilient projection 520 contacts the shield-side engaging portion 42 and is deformed away from the shield member 4. When the connector member 5 is further inserted into the shield member 4, the step portion 521 of the connector member 5 is stopped in contact with the shield-side engaging portion 42, whereby the insertion of the connector member 5 into the shield member 4 is completed. At this time, the resilient projection 520 rides over the shield-side engaging portion 42 and returns to an original shape. As a result, the shield-side engaging portion 42 is sandwiched between the resilient projection 520 and the step portion 521 (see FIG. 5). Since the shield-side engaging portion 42 is stopped in contact with the resilient projection 520 and the step portion 521, the connector member 5 is firmly fixed inside the shield member 4.

[First Terminals]

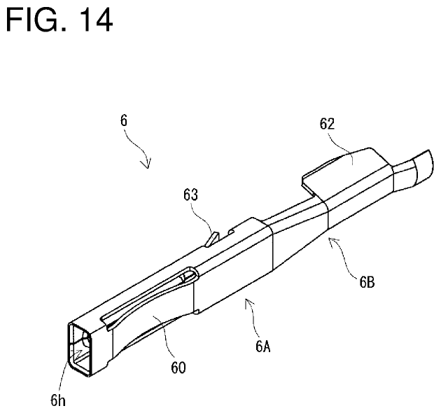

The first terminals 6 may be male or female terminals. The first terminals 6 of this example are female terminals. As shown in FIGS. 13 and 14, the first terminal 6 includes a tubular portion 6A and a connecting portion 6B. The tubular portion 6A includes a terminal hole 6h, into which the unillustrated mating terminal, i.e. a male terminal in this example, is inserted. By the mechanical contact of the first terminal 6 and the mating terminal, the both terminals are electrically connected. The first terminal 6 is obtained by press-working a plate material.

The tubular portion 6A includes a leaf spring portion 60 for pressing the outer peripheral surface of the mating terminal inserted into the terminal hole 6h. As shown in FIG. 14, the leaf spring portion 60 is constituted by a part of the tubular portion 6A. Specifically, one of side surfaces constituting the tubular portion 6A in the form of a rectangular tube constitutes the leaf spring portion 60. An end part of the leaf spring portion 60 on the side of the terminal hole 6h and an end part of the leaf spring portion 60 on the side of the connecting portion 6B are linked to the other side surfaces constituting the tubular portion 6A. Two corner parts of the tubular portion 6A on opposite sides of the leaf spring portion 60 are punched out. A central part of the leaf spring portion 60 in an axial direction of the tubular portion 6A is curved to bulge inwardly of the tubular portion 6A. The axial direction of the tubular portion 6A is an inserting/withdrawing direction of the mating terminal. Such a leaf spring portion 60 is easily fabricated by press-working. For example, the leaf spring portion 60 is formed only by punching out some of parts serving as corner parts of the tubular portion 6A, out of the plate material from which the first terminal 6 is formed, and fabricating the tubular portion 6A by press-working.

A pressing portion 61 concave toward the inside of the tubular portion 6A is provided on a side surface of the tubular portion 6A opposite to the leaf spring portion 60. The pressing portion 61 presses the mating terminal accommodated into the tubular portion 6A toward the leaf spring portion 60. As a result, the contact of the mating terminal and the leaf spring portion 60 is reliably ensured. The pressing portion 61 can also be simultaneously formed with the leaf spring portion 60 when the tubular portion 6A is press-worked.

The connecting portion 6B is a part to be electrically connected to the conductor 20 (FIG. 3) of the communication cable 2. The connecting portion 6B includes the wire barrel 62. The wire barrel 62 is a member for gripping the conductor 20. Here, the first terminal 6 of this example includes only the wire barrel 62 as a barrel for gripping the outer periphery of the communication cable 2. A conventional terminal includes an insulation barrel for gripping the sheath 24 of the communication cable 2, but the first terminal 6 of this example includes no insulation barrel.

The first terminal 6 includes the engaging claw 63 to be engaged with the engaging recess 56 of the connector member 5 (FIG. 8). The engaging claw 63 is formed by forming a cut in a part of the plate material constituting the first terminal 6 and bending the part formed with the cut. Thus, the engaging claw 63 acts like a leaf spring. The tip of the engaging claw 63 is facing toward the wire barrel 62. The first terminal 6 is inserted into the insertion hole 5h of the connector member 5 from the side of the pedestal portion 50B (see FIG. 8). When the first terminal 6 is inserted into the insertion hole 5h, the engaging claw 63 is deformed toward the inside of the tubular portion 6A. The engaging claw 63 returns to an original shape by the resilience thereof at a position corresponding to the engaging recess 56. The engaging claw 63 is hooked to the engaging recess 56 and the first terminal 6 is firmly fixed to the connector member 5.

A thickness of each part of the first terminal 6 is preferably 0.15 mm or less. The thickness of the shield member 4 formed of the cast body tends to be thicker than a shield member formed of a pressed body. To avoid the enlargement of the shield member 4, the connector member 5 and the first terminals 6 to be arranged inside the shield member 4 are preferably reduced in size. If the thickness of each part of the first terminal 6 is 0.15 mm or less, the first terminal 6 is easily reduced in size.

The thickness of each part of the first terminal 6 is preferably 0.05 mm or more. If this thickness of each part of the first terminal 6 is 0.05 mm or more, the strength of the first terminal 6 can be ensured. The thickness of each part of the first terminal 6 is preferably 0.075 mm or more and 0.13 mm or less, more preferably 0.080 mm or more and 0.10 mm or less. The thickness mentioned here does not include a thickness of an edge formed by bending the plate material constituting the first terminal 6.

The first terminal 6 is made of the material excellent in conductivity. The first terminal 6 includes no protecting portion for covering the outer periphery of the leaf spring portion 60 unlike conventional terminals. Thus, the first terminal 6 of this example is preferably made of a material excellent in strength. An example of the material excellent in conductivity and strength is stainless steel. Stainless steels preferable for the first terminal 6 of this example are, for example, 1.4372, 1.4373, 1.4310, 1.4318, 1.4305, 1.4307, 1.4306, 1.4311, 1.4303, 1.4401, 1.4436, 1.4404, 1.4432, 1.4435, 1.4406, 1.4429, 1.4571, 1.4438, 1.4434, 1.4439, 1.4539, 1.4541, 1.4550, 1.4587, 1.4381, 1.4462, 1.4507 and 1.4002 in European standards. Among these, 1.4310 and 1.4318 are, for example, preferable in terms of conductivity and strength. The surface of the first terminal 6 is preferably plated with a material excellent in conductivity. A plating material is, for example, tin (Sn) or silver (Ag).

The first terminal 60 configured as described above has a very simple configuration. Particularly, the first terminal 6 has no configuration for covering the leaf spring portion 60 and the pressing portion 61 from outside. Thus, the leaf spring portion 60 and the pressing portion 61 can be simultaneously fabricated when the tubular portion 6A is press-worked. Therefore, the first terminal 6 of this example can be more easily fabricated than conventional terminals.

### Effects

The conductive rubber member 7 of the first embodiment has the first region 71 to be accommodated into the accommodating portion 47 of the shield member 4 and the second region 72 not to be accommodated into the accommodating portion 47. The first region 71 electrically connects the shielding layer 23 of the communication cable 2 and the shield member 4 by the first projections 71p. Since the shield member 4 is grounded, an induced current flowing in the shielding layer 23 can be released to ground via the first region 71 of the conductive rubber member 7 and the shield member 4. On the other hand, the second region 72 ensures water cut-off performance between the communication cable with connector 1 and the wall portion 90A of the outer housing 90 by the second projection 72p when the communication cable with connector 1 is accommodated into the outer housing 90 to configure the connector assembly 9 (FIG. 18). The first and second regions 71, 72 constitute the integrally molded body. Thus, the conductive rubber member 7 as a single member has both a function of a conductive member to release the induced current flowing in the shielding layer 23 of the communication cable 2 to ground and a water cut-off function to suppress the flow of environmental water toward the accommodating portion 47 in the connector assembly 9. Therefore, the connector module 3 of the first embodiment can be composed of a smaller number of components and better in productivity as compared to the case where the function of the conductive member and the water cut-off function are individually configured.

The step is formed between the outer peripheral surface of the shielding layer 23 and the outer peripheral surface of the sheath 24 by the end surface of the sheath 24 in the stripped end part of the communication cable 2. The conductive rubber member 7 includes the small-diameter portion h1, the large-diameter portion h2 and the step h3 to correspond to the shielding layer 23, the sheath 24 and the step. Since the conductive rubber member 7 is shaped to correspond to the shape of the communication cable 2, the conductive rubber member 7 is more easily held in close contact with the communication cable 2. By providing the conductive rubber member 7 with the step h3, the step h3 is stopped in contact with the end surface of the sheath 24. That is, the conductive rubber member 7 is hooked to the end surface of the sheath 24. By this hooking, the conductive rubber member 7 can be firmly mounted on the communication cable 2. This is because the conductive rubber member 7 is less likely to move in the axial direction by being hooked to the end surface of the sheath 24 due to the resilience of the conductive rubber member 7. Particularly, since the end surface of the sheath 24 and the step h3 of the conductive rubber member 7 are at the same position as the first projection 71p of the conductive rubber member 7 along the axial direction of the conductive rubber member 7, the conductive rubber member 7 can be more firmly mounted on the communication cable 2. The first projections 71p are in contact with the inner peripheral surface of the accommodating portion 47 and pressed radially inward. Thus, the above pressing force is applied to the region near the step h3 due to the step h3 located at the same position as the first projection 71p along the axial direction of the conductive rubber member 7.

<First Modification>

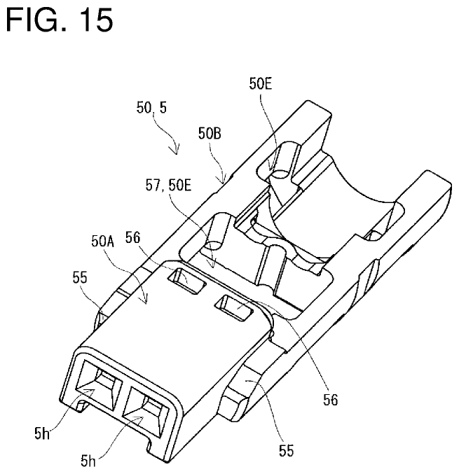

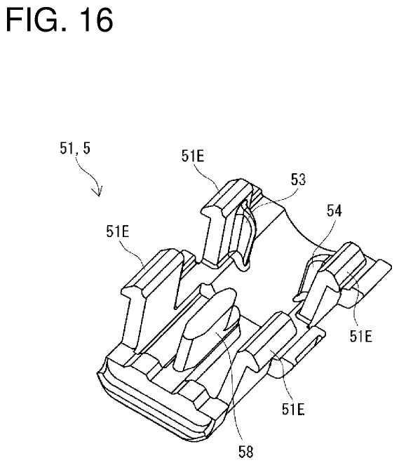

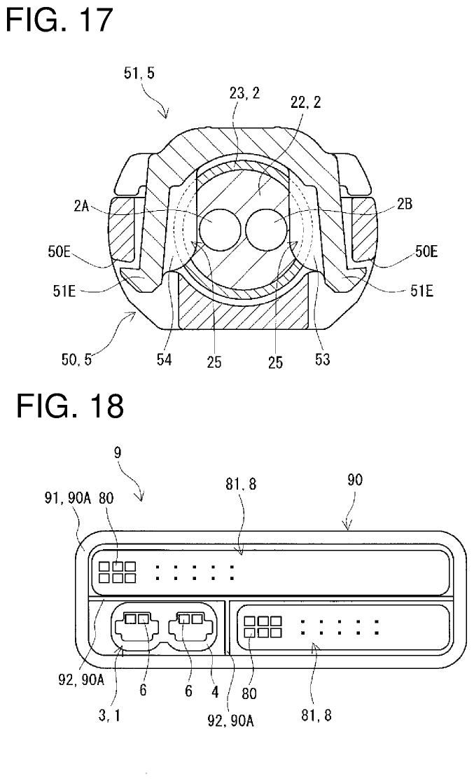

A communication cable with connector 1 including a connector member 5 different from the first embodiment in the configurations of clamp portions 53, 54 is described with reference to FIGS. 15 to 17. FIG. 15 is a perspective view of a housing 50 of the connector member 5 viewed from an inner peripheral side. FIG. 16 is a perspective view of a cover 51 viewed from the inner peripheral side. FIG. 17 is a section of the communication cable with connector 1 along a direction orthogonal to a longitudinal direction of the communication cable with connector 1 at the position of the clamp portions 53, 54.

As shown in FIG. 15, the housing 50 of this example includes no clamp portion on the inner peripheral surface of a pedestal portion 50B. On the other hand, the cover 51 of this example includes two clamp portions 53, 54 on the inner peripheral surface thereof as shown in FIG. 16. The clamp portions 53, 54 are spaced apart in a width direction of the cover 51. Specifically, the clamp portion 53 is provided on the inner peripheral surface of one cover-side engaging portion 51E, out of two cover-side engaging portions 51E on a rear end side of the cover 51, and the clamp portion 54 is provided on the inner peripheral surface of the other cover-side engaging portion 51E. The clamp portions 53, 54 are curved plate-like members convex toward a side opposite to a partitioning portion 58. Thus, the tips of the clamp portions 53, 54 are arranged closer to the partitioning portion 58 than base ends of the clamp portions 53, 54, i.e. closer to the first terminals 6 shown in FIG. 3. Further, the clamp portions 53, 54 are gradually thinned from the base ends to the tips thereof. The clamp portions 53, 54 are both integrally connected to a body portion of the cover 51. Thus, the clamp portions 53, 54 also function as reinforcing members for the cover-side engaging portions 51E.

In the communication cable with connector 1 using the connector member 5 of this example, the clamp portions 53, 54 provided in the cover 51 sandwich the outer periphery of the communication cable 2 as shown in FIG. 17. At that time, the clamp portions 53, 54 bite into the cut portions 25 provided in the interposed insulation layer 22. Also by this configuration, the connector member 5 is firmly fixed to the end part of the communication cable 2.

### Second Embodiment

The connector assembly 9 including the communication cable with connector 1 of the first embodiment is described on the basis of FIG. 18. FIG. 18 is a schematic front view of the connector assembly 9 viewed from a side where the first terminals 6 and second terminals 80 are exposed. The connector assembly 9 of this example includes the communication cable with connector 1 of the first embodiment, the signal cable 8 and the outer housing 90.

The signal cable 8 is a cable for transmitting electrical signals. The signal cable 8 includes a plurality of the second terminals 80 and an inner housing 81 for accommodating the plurality of second terminals 80. Since the first terminals 6 are female terminals in this example, the second terminals 80 are also female terminals. If the first terminals 6 are male terminals, the second terminals 80 are also male terminals. The outer housing 90 collectively accommodate the respective end parts of the communication cable with connector 1 and the signal cable 8. In this example, the outer housing 90 collectively accommodates the connector module 3 of the communication cable with connector 1 and the inner housing 81 of the signal cable 8. The outer housing 90 includes a tube portion 91 and a partitioning portion 92. The tube portion 91 constitutes the external appearance of the outer housing 90. The partitioning portion 92 partitions the inside of the tube portion 91 into a plurality of sections. The outer housing 90 of this example has a space for accommodating the communication cable with connector 1 and a space for accommodating the signal cable 8 by partitioning the inside of the tube portion 91 by the partitioning portion 92.

The connector assembly 9 including the communication cable with connector 1 facilitates the construction of a communication environment in an automotive vehicle. If the connector assembly 9 is connected to a male connector assembly (not shown) provided on a circuit board of an in-vehicle device, a transmission route of the signal cable and a transmission route of the communication cable are simultaneously constructed.

The communication cable with connector 1 includes the conductive rubber member 7 (FIGS. 4 and 5) provided with the second projection 72p as described above. If the end part of the communication cable with connector 1 is accommodated into the outer housing 90, the second projection 72p (FIGS. 4 and 5) is held in close contact with the wall portion 90A configured by the tube portion 91 and the partitioning portion 92 in the outer housing 90. By the close contact of the second projection 72p and the wall portion 90A, the intrusion of environmental water toward the connector module 3 through a clearance between the communication cable with connector 1 and the outer housing 90 can be suppressed.

A total number of the first terminals 6 and the second terminals 80, i.e. the number of poles, is preferably 200 or less. If the number of poles is 20 or more, many transmission routes can be constructed by one connection of the connector assembly 9. If the number of poles is 200 or less, connection resistance does not become too high when the female connector assembly 9 of this example is connected to the male connector assembly.

Pitches of the second terminals 80 are preferably 0.1 mm or more and 2.0 mm or less. If the pitches of the second terminals 80 are within the above range, the connector assembly 9 is easily reduced in size. If the connector assembly 9 can be reduced in size, the connector assembly 9 of a size corresponding to the male connector assembly provided on the circuit board is easily fabricated.

### LIST OF REFERENCE NUMERALS

1 communication cable with connector
2 communication cable
2A, 2B wire
20 conductor, 21 conductor insulation layer, 22 interposed insulation layer
23 shielding layer, 24 sheath, 25 cut portion
3 connector module
4 shield member
4A tubular portion, 4B coupling portion
40 opening, 41 first guide portion, 42 shield-side engaging portion, 43 thick
44 portion
44 protruding portion, 47 accommodating portion
5 connector member
5h insertion hole
50 housing
50A connector tube portion, 50B pedestal portion, 50E housing-side engaging portion
51 cover, 51E cover-side engaging portion
52 connector-side engaging portion, 520 resilient projection, 521 step portion
53, 54 clamp portion, 55 second guide portion
56 engaging recess, 57 through hole, 58 partitioning portion, 59 arched portion
6 first terminal
6A tubular portion, 6B connecting portion, 6h terminal hole
60 leaf spring portion, 61 pressing portion, 62 wire barrel, 63 engaging claw
7 conductive rubber member
70h cable hole, h1 small-diameter portion, h2 large-diameter portion, h3 step
71 first region, 71p first projection
72 second region, 72p second projection
8 signal cable
80 second terminal, 81 inner housing
9 connector assembly
90 outer housing, 90A wall portion, 91 tube portion, 92 partitioning portion
10 ground terminal

1. A connector module provided on an end part of a communication cable used in communication of 100 Mbps or faster, comprising:
a first terminal;
a connector member for accommodating the first terminal;
a tubular shield member for covering an outer periphery of the connector member; and
a tubular conductive rubber member to be electrically connected to the shield member,
wherein:
the shield member includes an accommodating portion for accommodating a part of the conductive rubber member on a side where an end part of the communication cable is inserted,
the conductive rubber member includes a first region to be accommodated into the accommodating portion and a second region not to be accommodated into the accommodating portion,
the first and second regions constitute an integrally molded body,
the second region has a larger outer diameter than the first region,
an outer peripheral surface of the first region includes a first projection to be held in contact with an inner peripheral surface of the accommodating portion, and
an outer peripheral surface of the second region includes an annular second projection.

2. The connector module according to claim 1, wherein the conductive rubber member is made of silicone rubber.

3. The connector module according to claim 1, wherein the conductive rubber member contains a conductive filler.

4. The connector module according to claim 1, wherein the conductive rubber member includes:
a small-diameter portion to be held in close contact with a shielding layer of the communication cable;
a large-diameter portion having a larger inner diameter than the small-diameter portion and to be held in close contact with a sheath of the communication cable, and
a step formed between the small-diameter portion and the large-diameter portion, an end surface of the sheath being hooked to the step.

5. The connector module according to claim 4, wherein:
the step is located in the accommodating portion, and
the first projection and the step are at the same position along an axial direction of the conductive rubber member.

6. The connector module according to claim 1, wherein the shield member is a cast body.

7. The connector module of claim 6, wherein the shield member has no hole open in a peripheral surface of the shield member.

8. The connector module according to claim 6, wherein a minimum value of a thickness of the shield member is 0.25 mm or more and 1.0 mm or less.

9. The connector module according to claim 1, wherein Ethernet (registered trademark) standards are satisfied.

10. The connector module according to claim 1, wherein:
the first terminal includes an engaging claw, and
the connector member includes an engaging recess to be locked to the engaging claw.

11. A communication cable with connector, comprising:
the connector module according to claim 1, and
a communication cable including a conductor to be electrically connected to the first terminal.

12. The communication cable with connector according to claim 11, wherein the communication cable is a twisted pair cable.

13. A connector assembly, comprising:
the communication cable with connector according to claim 11;
a signal cable arranged in parallel with the communication cable with connector; and
an outer housing for collectively accommodating end parts of the communication cable with connector and the signal cable,
wherein:
the outer housing includes a wall portion constituting a space for accommodating the connector module, and
the second projection is in close contact with the wall portion.

14. The connector assembly according to claim 13, wherein:
the signal cable includes a plurality of second terminals, and
pitches of the second terminals are 0.1 mm or more and 2.0 mm or less.
